(19) United States
(12) Patent Application Publication
(10) Pub. No.: US 2026/0112840 A1
(43) Pub. Date: Apr. 23, 2026

(54) WIRE DRESS COVER FOR ELECTRICAL CONNECTOR

(71) Applicant: Aptiv Technologies AG, Schaffhausen (CH)

(72) Inventors: Jack Farrell, Warren, OH (US); Daniel Vernon, Youngstown, OH (US); Siddhan MANICKAM, Tamilnadu (IN)

(21) Appl. No.: 19/338,494

(22) Filed: Sep. 24, 2025

Related U.S. Application Data
(60) Provisional application No. 63/710,256, filed on Oct. 22, 2024.

(51) Int. Cl. H01R 13/506; H01R 13/424

(52) U.S. Cl. CPC H01R 13/506; H01R 13/424

(57) ABSTRACT

A wire dress cover configured to attach to a connector housing containing a terminal includes a tab extending from the cover and configured for insertion into a slot defined in the connector housing. The tab features a locking surface that contacts a wall of the slot, the locking surface and wall cooperating to urge a contact surface of the cover against the terminal within the connector housing, thereby maintaining secure electrical engagement and providing strain relief.

### CROSS-REFERENCE TO RELATED APPLICATIONS

This application claims the benefit of and priority to U.S. Provisional Application 63/710,256, titled “Wire Dress Cover”, filed Oct. 22, 2024, the contents of which are incorporated by reference herein.

### TECHNICAL FIELD

The subject matter disclosed herein relates to a wire dress cover for an electrical connector, more particularly to a wire dress cover including a tab having a locking surface for terminal engagement.

### BACKGROUND

Previous approaches to wire dress covers for electrical connectors have typically involved designs that focus on providing a protective covering for wires and terminals within a connector housing. These conventional wire dress covers are often designed to simply encase the wires and terminals without providing any additional functionality or features to improve the connection between the wire dress cover and the connector housing. In some cases, wire dress covers may include basic locking mechanisms or fastening elements to secure the cover to the housing, but these mechanisms are often limited in their effectiveness and may not provide a secure and reliable attachment.

In existing wire dress cover designs, the attachment mechanisms are generally separate components from the cover itself, requiring additional assembly steps and potentially increasing the complexity of the overall connector assembly process. These attachment mechanisms may rely on external fasteners or clips that can be cumbersome to install and may not provide a tight and secure fit between the wire dress cover and the connector housing. As a result, there is a need in the art for an improved wire dress cover design that simplifies the attachment process and ensures a secure and reliable connection between the cover and the housing.

Furthermore, traditional wire dress covers may lack features that actively engage with the connector housing to exert a force on the terminal within the housing. Without such features, the wire dress cover may not provide sufficient support or stability to the terminal, potentially leading to issues such as poor electrical contact or mechanical failure. Therefore, there is a demand for a wire dress cover that incorporates innovative design elements to enhance the connection between the cover and the housing, ensuring proper contact with the terminal and improving the overall performance and reliability of the connector assembly. However, none of these approaches have provided a comprehensive solution that combines the features described in this disclosure.

Currently, wire dress covers for right-angled data cable connector systems are not widely available. The lack of a wire dress cover for these data cable connectors may lead to robustness concerns and issues with terminal ring out during wiring harness assembly. In some applications, the data cable connector housings may be only partially populated which means could lead to robustness issues if the terminal elbow is used as a push surface. Also, without a wire dress cover, there is nothing to prevent the outer shields of the terminals in connector having multiple terminals from touching. If the outer shields are in contact, it is not possible to individually ring out the outer shields and thereby improper assembly of the data cable connector may go undetected. Additionally, there are additional manufacturing costs to attaching a wire dress cover.

### SUMMARY

In some aspects, the techniques described herein relate to a wire dress cover configured to be attached to a connector housing containing a terminal, including: a tab extending from the wire dress cover, the tab configured to be inserted within a slot defined in the connector housing, the tab having a locking surface configured to contact a wall in the slot, the locking surface and the wall being configured to cooperatively urge a contact surface of the wire dress cover to exert a force on the terminal within the connector housing.

In some aspects, the techniques described herein relate to an electrical connector assembly, including: a connector housing having a terminal cavity configured to receive an electrical terminal having a connection portion extending along a first axis and an attachment portion extending along a second axis askew to the first axis, the connector housing defining a slot having a wall substantially parallel with the second axis; and a wire dress cover attached to the connector housing by a tab inserted within the slot, a locking surface of the tab being in contact with the wall of the slot, the locking surface and the wall being configured to cooperatively urge a contact surface of the wire dress cover to exert a force on the electrical terminal along the first axis.

In some aspects, the techniques described herein relate to an electrical wiring assembly, including: an electrical terminal having a connection portion extending along a first axis and an attachment portion connected to an electrical cable extending along an a second axis askew to the first axis; a connector housing having a terminal cavity in which the electrical terminal is received, the connector housing defining a slot having a wall substantially parallel with the second axis; and a wire dress cover attached to the connector housing by a tab inserted within the slot, a locking surface of the tab being in contact with the wall of the slot, the locking surface and the wall being configured to urge a contact surface of the wire dress cover to exert a force on the electrical terminal along the first axis.

### BRIEF DESCRIPTION OF THE DRAWINGS

FIG. 1 is an isometric view of an electrical wiring assembly according to some embodiments.

FIG. 2A is a cross-section side view of the electrical wiring assembly of FIG. 1 according to some embodiments.

FIG. 2B is close-up detail view of the cross-section side view of the electrical wiring assembly of FIG. 2A according to some embodiments.

FIG. 3 is a cross-section side view of the electrical wiring assembly of FIG. 1 connected to a corresponding mating connector according to some embodiments.

FIGS. 4A to 4C are a rear views of alternative orientations between the housing and the wire dress cover of the electrical wiring assembly of FIG. 1 according to some embodiments.

FIG. 5 is a graph of mating force vs. displacement for the electrical wiring assembly of FIG. 1 as it is connected with the corresponding mating connector according to some embodiments.

FIG. 6 is an isometric view of an electrical wiring assembly containing a pair of wire cables according to some embodiments.

FIG. 7A is a rear view of the electrical wiring assembly of FIG. 6 according to some embodiments.

FIG. 7B is cross-section side view of the electrical wiring assembly of FIG. 6 along the section line 7B-7B in FIG. 7A according to some embodiments.

FIGS. 8A to 8C are a rear views of alternative orientations between the housing and the wire dress cover of the electrical wiring assembly of FIG. 6 according to some embodiments.

FIG. 9 is an isometric view of an electrical wiring assembly containing a quartet of wire cables according to some embodiments.

FIG. 10A is cross-section side view of the electrical wiring assembly of FIG. 9 along the section line 10A-10A in FIG. 9 according to some embodiments.

FIG. 10B is another cross-section side view of the electrical wiring assembly of FIG. 9 along the section line 10B-10B in FIG. 9 according to some embodiments.

FIGS. 11A to 11C are a rear views of alternative orientations between the housing and the wire dress cover of the electrical wiring assembly of FIG. 9 according to some embodiments.

### DETAILED DESCRIPTION

The present disclosure describes a wire dress cover that is configured to be attached to a connector housing containing a terminal terminating a wire cable. The wire dress cover not only directs the cable in the desired orientation but also locates the terminal in the desired location withing the connector housing and provides a back-up terminal retention feature, i.e., an integrated secondary lock (ISL).

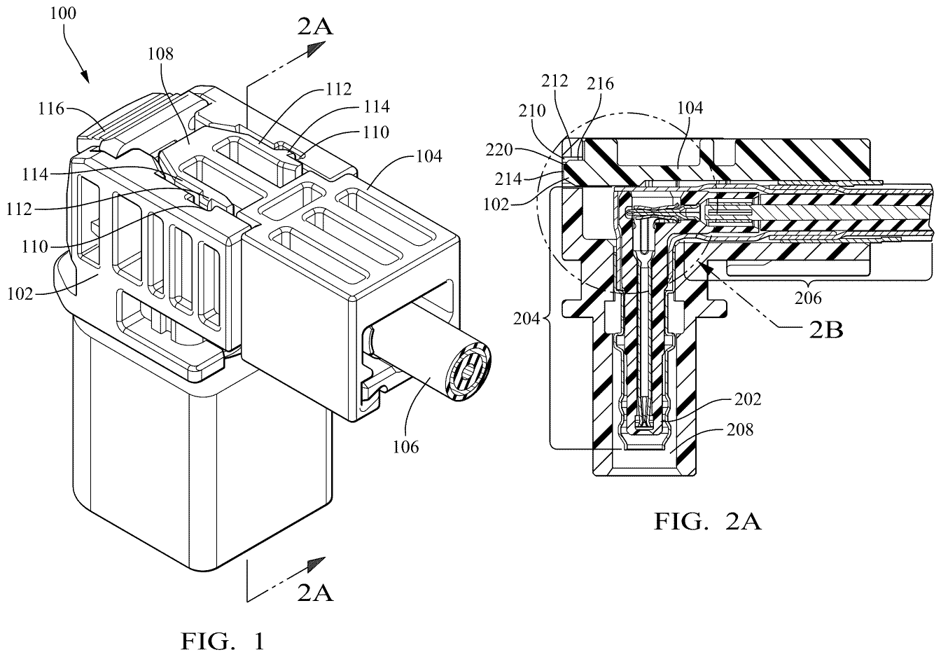

FIG. 1 is an isometric view of an electrical wiring assembly 100 having a connector housing 102 with a wire dress cover 104 and an electrical cable 106 attached to an electrical terminal within the connector housing 102.

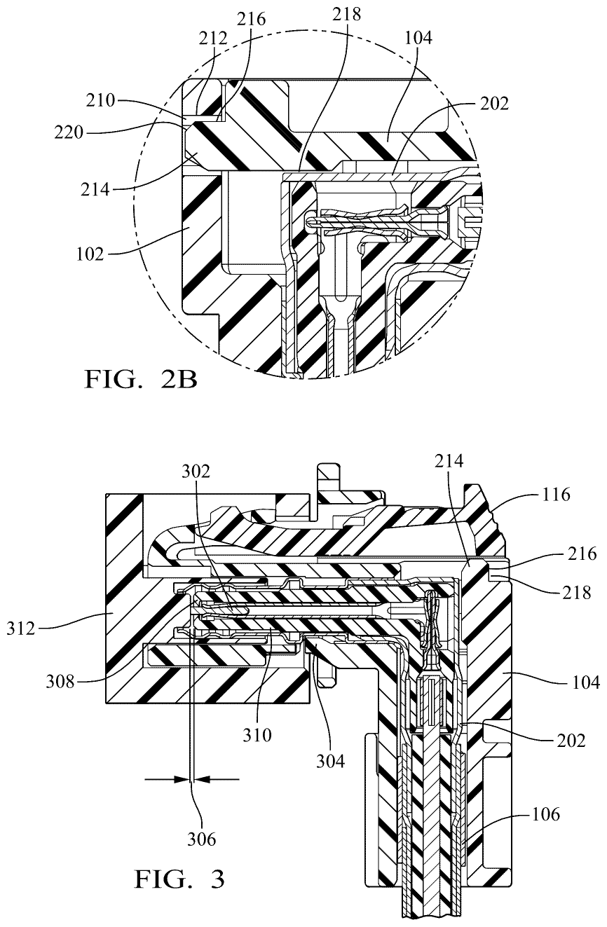

As shown in FIGS. 2A and 2B, the electrical wiring assembly 100 includes the electrical terminal 202 which has a connection portion 204 extending along a first axis X and an attachment portion 206 connected to the electrical cable 106 extending along a second axis Y. The first axis X is arranged askew to the second axis Y, i.e., the first axis X is not coaxial or parallel to the second axis Y. The connection portion 204 is configured to interface and mate with a corresponding electrical terminal 302 shown in FIG. 3 while the attachment portion 206 is configured to attach the electrical terminal 202 to the electrical cable 106. In the illustrated example, the electrical terminal 202 is a right-angled terminal meaning that the first axis X of the connection portion 204 is arranged at substantially a 90 degree angle to the second axis Y of the attachment portion 206. As used herein, “substantially perpendicular” means ±5 degrees of being absolutely perpendicular. Further, in the illustrated example, the electrical cable 106 is a coaxial cable, and the electrical terminal 202 is a coaxial terminal. Alternative embodiments may be envisioned with other cable or conductor types and other terminal types.

As further shown in FIGS. 2A and 2B, the connector housing 102 has a terminal cavity 208 in which the electrical terminal 202 is received. The connector housing 102 defines a slot 210 having a wall 212 which is substantially parallel with the second axis Y. As used herein, “substantially parallel” means ±5 degrees of being absolutely parallel.

FIGS. 2A and 2B also show that the wire dress cover 104 is attached to the connector housing 102 by a tab 214 extending from the wire dress cover 104 that is inserted within the slot 210. A locking surface 216 of the tab 214 is in contact with the wall 212 of the slot 210. The locking surface 216 and the wall 212 are configured to urge a contact surface 218 of the wire dress cover 104 to exert a force F on the electrical terminal 202 along the first axis X. A leading edge 220 of the tab 214 is beveled and generates the force F on the electrical terminal along the first axis X as the tab 214 is inserted within the slot 210. The first side of the wire dress cover 104 defines the locking surface 216 and a second side of the wire dress cover 104 opposite the first side comprises the contact surface 218.

As shown in FIG. 3, the connector housing 102 has a primary locking feature 304 that is configured to secure the electrical terminal 202 within the terminal cavity 208. The wire dress cover 104 provides a secondary locking feature, i.e., and ISL, that is configured to further secure the electrical terminal 202 within the terminal cavity 208 by contacting the electrical terminal 202 via the contact surface 218 and inhibiting removal of the electrical terminal 202 from the terminal cavity 208.

As also shown in FIG. 3, the force F on the electrical terminal 202 along the first axis X reduces a gap 306 between a free end 308 of an insulator 310 containing the connection portion 204 and a corresponding mating connector housing 312 holding the corresponding electrical terminal 302 proximate an end of the terminal cavity 208, thereby reducing a gap between a free end of the connection portion 204 and the mating connector housing 312. Extensive test data has indicated that the resulting smaller air gap between the connection portion 204 and the mating connector housing 312 provides improved signal integrity performance.

Returning to FIG. 1, the wire dress cover 104 has a cover locking feature 108 that is configured to cooperate with a corresponding cover locking feature 110 in the connector housing 102 to maintain the tab 214 within the slot 210. The cover locking feature 108 includes a pair of cantilevered resilient arms 112. Each arm 112 defines a locking latch 114 near a free end of each arm 112. The corresponding cover locking feature 110 includes notches in the connector housing 102 that are configured to receive the locking latch 114 of each arm 112. The electrical wiring assembly 100 may also include a connector position assurance (CPA) device 116.

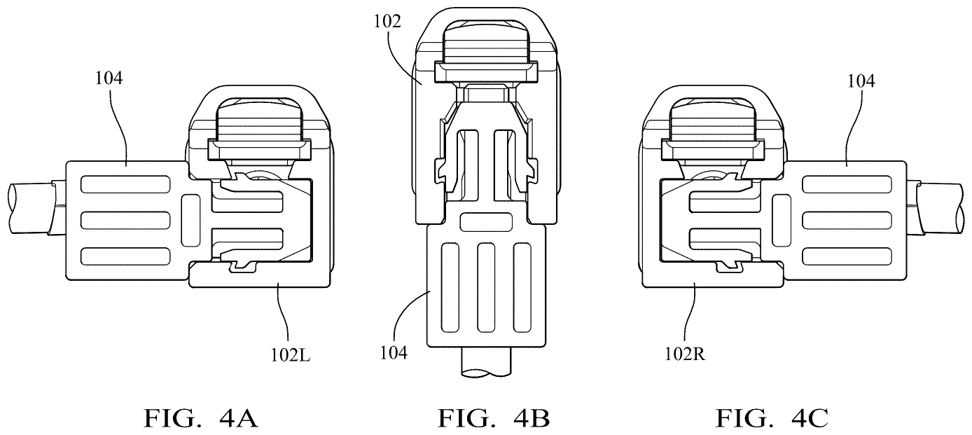

As shown in FIGS. 4A, 4B, and 4C, a common wire dress cover 104 design may be used with connector housings providing different cable exit orientations, such as the bottom cable orientation of connector housing 102 shown in FIG. 4B, the left cable orientation of connector housing 102L shown in FIG. 4A, and the right cable orientation of connector housing 102R shown in FIG. 4C.

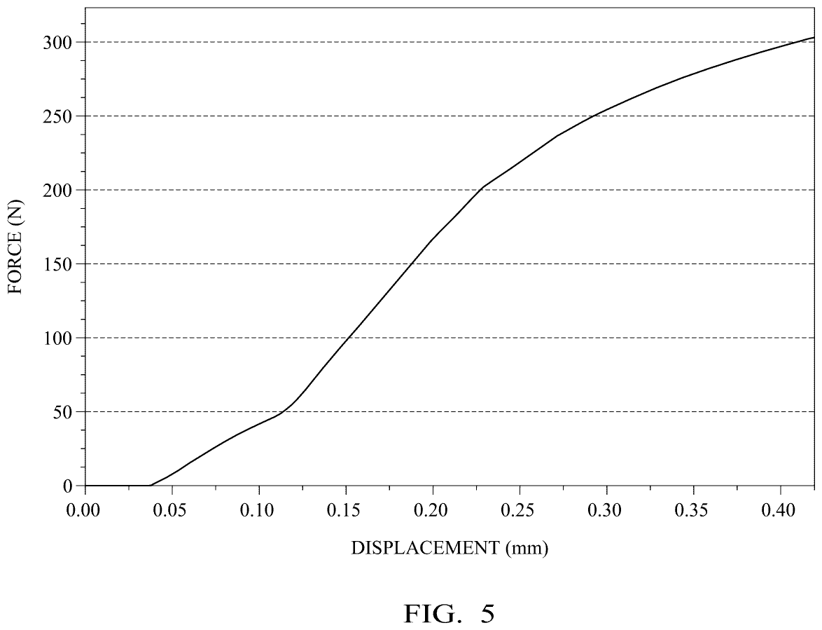

FIG. 5 shows a graph of force vs. displacement for the retention force provided by the wire dress cover 104 for retaining the electrical terminal 202 within the terminal cavity 208 of the connector housing 102.

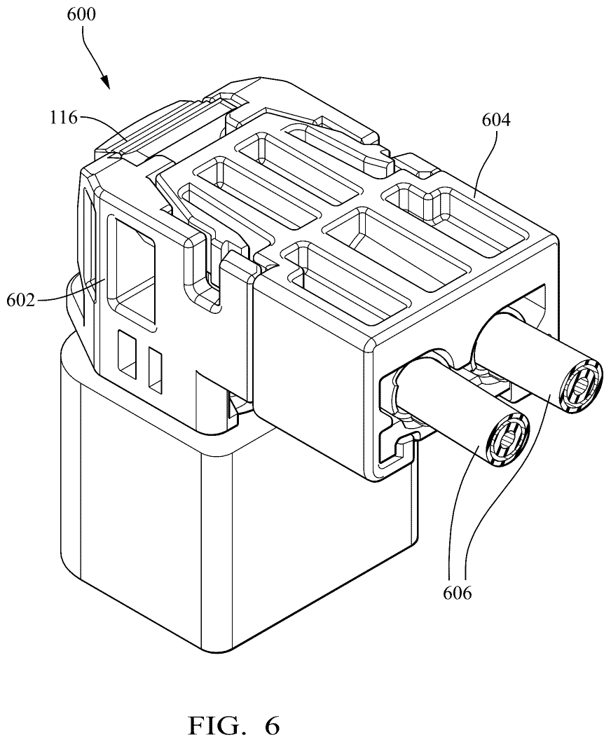

FIG. 6 shows another example of an electrical wiring assembly 600 having a connector housing 602 with a wire dress cover 604 and a pair of electrical cables 606 attached to a pair of electricals terminal within the connector housing 602.

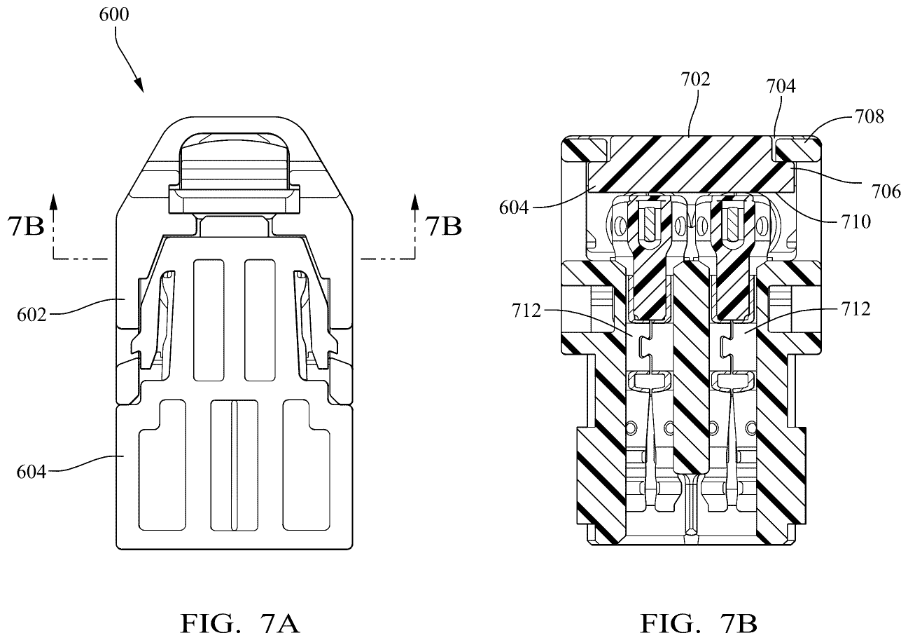

FIG. 7A shows a rear view of the electrical wiring assembly 600. FIG. 7B shows a cross section view of the electrical wiring assembly 600 along the section line 7B-7B in FIG. 7A. As shown in FIG. 7B, the wire dress cover 604 is attached to the connector housing 602 by a tab 702 extending from the wire dress cover 604 that is inserted within a slot 704 in the connector housing 602. A locking surface 706 of the tab 702 is in contact with a wall 708 of the slot 704. The locking surface 706 and the wall 708 are configured to urge a contact surface 710 of the wire dress cover 604 to exert a force F on the pair of electrical terminals 712 along the axis X. The first side of the wire dress cover 604 defines the locking surface 706 and the second side of the wire dress cover 604 opposite the first side comprises the contact surface 710.

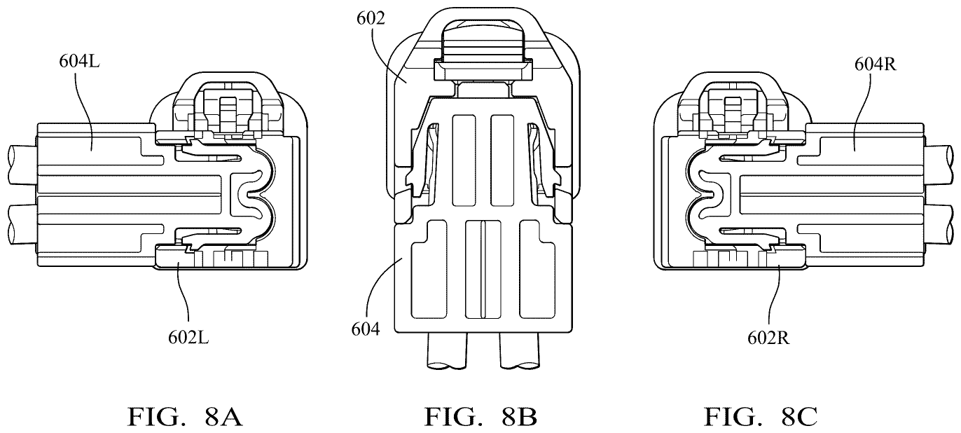

As shown in FIGS. 8A, 8B, and 8C, a unique wire dress cover design may be needed with connector housings providing different cable exit orientations for the pair of electrical cables 606, such as wire dress cover 604 with the bottom cable orientation of connector housing 602 shown in FIG. 8B, the wire dress cover 604L with the left cable orientation of connector housing 602L shown in FIG. 8A, and the wire dress cover 604R with the right cable orientation of connector housing 602R shown in FIG. 8C. The different wire dress covers 604, 604L, 604R may be driven by the use of one long and one short terminal in the pair of electrical terminals 712 for right and left cable exit orientations.

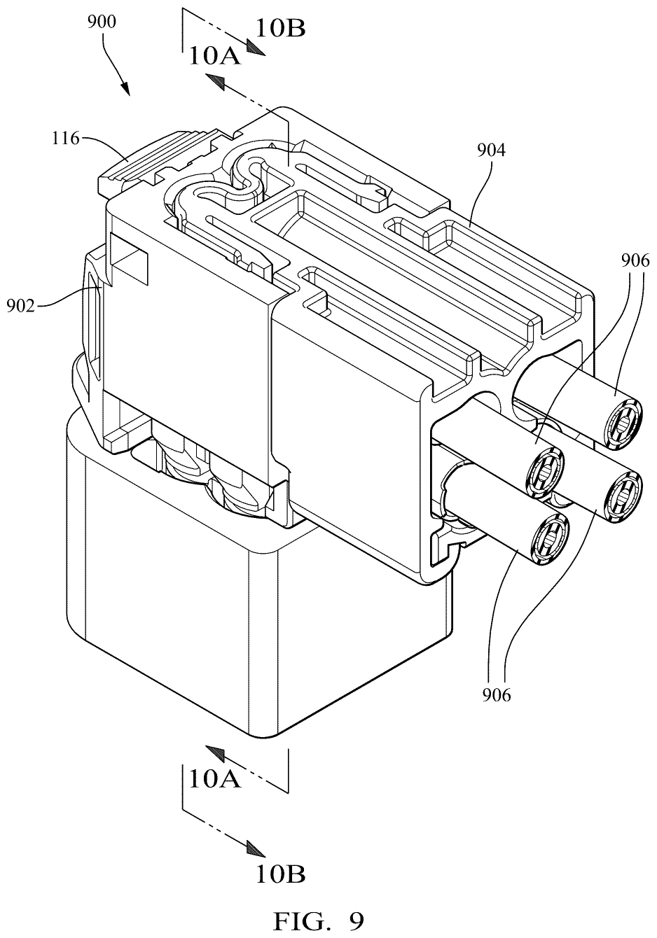

FIG. 9 shows another example of an electrical wiring assembly 900 having a connector housing 902 with a wire dress cover 904 and a quartet of electrical cables 906 attached to a quartet of electricals terminal within the connector housing 902.

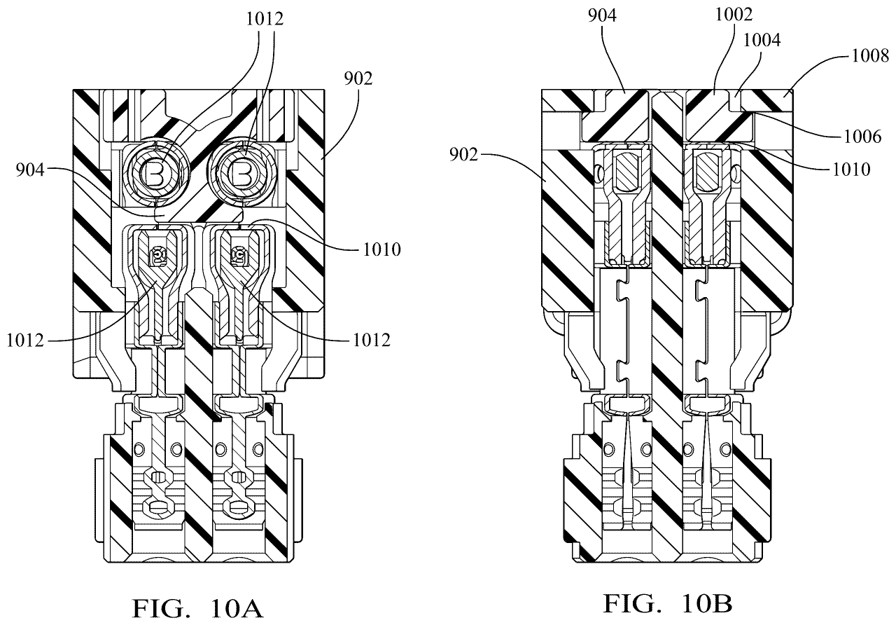

FIG. 10A shows a cross section view of the electrical wiring assembly 900 along the section line 10A-10A in FIG. 9. FIG. 10B shows a cross section view of the electrical wiring assembly 900 along the section line 10B-10B in FIG. 9. As shown in FIG. 10B, the wire dress cover 904 is attached to the connector housing 902 by a tab 1002 extending from the wire dress cover 904 that is inserted within a slot 1004 in the connector housing 902. A locking surface 1006 of the tab 1002 is in contact with a wall 1008 of the slot 1004. The locking surface 1006 and the wall 1008 are configured to urge a contact surface 1010 of the wire dress cover 904 to exert a force F on the pair of electrical terminals 1012 along the axis X. The first side of the wire dress cover 904 defines the locking surface 1006 and the second side of the wire dress cover 904 opposite the first side comprises the contact surface 1010.

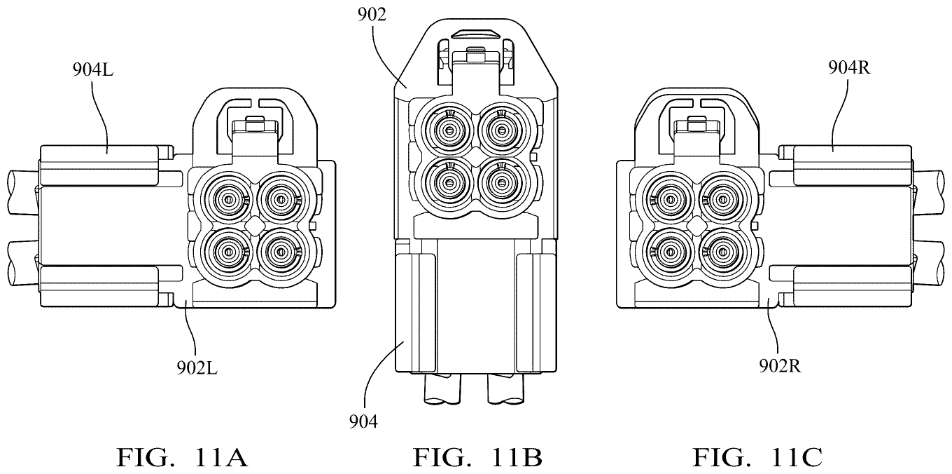

As shown in FIGS. 11A, 11B, and 11C, a common wire dress cover 104 design may be used with connector housings providing different cable exit orientations, such as the bottom cable orientation of connector housing 902 shown in FIG. 11B, the left cable orientation of connector housing 902L shown in FIG. 11A, and the right cable orientation of connector housing 902R shown in FIG. 11C.

The wire dress covers presented herein, in addition to providing a wire dress and covering the attachment position of the terminal(s) in the electrical wire assemblies, also offer the function of an ISL without the need to incorporate a separate ISL, thereby affording parts and assembly cost savings.

While the wire dress cover presented herein is configured for use with a right-angled connector assembly, alternative embodiments may also be envisioned for connector assemblies wherein the connection portion of the electrical terminal arranged at an angle greater than 0 degrees but less than 90 degrees relative to the attachment portion of the electrical terminal.

While the wire dress cover presented herein is configured to be arranged at one of several predetermined orientations relative to the connector housing, alternative embodiments of the wire dress cover may be envisioned in which the wire dress cover may be arranged in any orientation relative to the connector housing.

While the examples presented herein are directed to a wire dress cover for an electrical connector, alternative embodiments of the dress cover may be envisioned that are configured for fiber optic connectors, pneumatic connectors, hydraulic connectors, or a hybrid connector containing a combination of any of these types of conductors.

### Discussion of Possible Embodiments

The following are non-exclusive descriptions of possible embodiments of the present invention.

In some aspects, the techniques described herein relate to a wire dress cover configured to be attached to a connector housing containing a terminal, including: a tab extending from the wire dress cover, the tab configured to be inserted within a slot defined in the connector housing, the tab having a locking surface configured to contact a wall in the slot, the locking surface and the wall being configured to cooperatively urge a contact surface of the wire dress cover to exert a force on the terminal within the connector housing.

The wire dress cover of the preceding paragraph can optionally include, additionally and/or alternatively any, one or more of the following features/steps, configurations, and/or additional components.

In some aspects, the techniques described herein relate to a wire dress cover, further including a locking feature configured to secure the terminal within the connector housing.

In some aspects, the techniques described herein relate to a wire dress cover, wherein the first side of the wire dress cover includes the locking surface and the second side of the wire dress cover opposite the first side includes the contact surface.

In some aspects, the techniques described herein relate to a wire dress cover, wherein a leading edge of the tab is beveled and is configured to generate the force on the terminal as the tab is inserted within the slot.

In some aspects, the techniques described herein relate to a wire dress cover, wherein the wire dress cover includes a cover locking feature configured to cooperate with a corresponding cover locking feature in the connector housing to maintain the tab within the slot.

In some aspects, the techniques described herein relate to a wire dress cover, wherein the cover locking feature includes a pair of cantilevered resilient arms, each arm defining a locking latch near a free end of each arm.

In some aspects, the techniques described herein relate to an electrical connector assembly, including: a connector housing having a terminal cavity configured to receive an electrical terminal having a connection portion extending along a first axis and an attachment portion extending along a second axis askew to the first axis, the connector housing defining a slot having a wall substantially parallel with the second axis; and a wire dress cover attached to the connector housing by a tab inserted within the slot, a locking surface of the tab being in contact with the wall of the slot, the locking surface and the wall being configured to cooperatively urge a contact surface of the wire dress cover to exert a force on the electrical terminal along the first axis.

The electrical connector assembly of the preceding paragraph can optionally include, additionally and/or alternatively any, one or more of the following features/steps, configurations, and/or additional components.

In some aspects, the techniques described herein relate to an electrical connector assembly, wherein the first axis is arranged substantially perpendicular to the second axis.

In some aspects, the techniques described herein relate to an electrical connector assembly, wherein the connector housing includes a primary locking feature configured to secure the electrical terminal within the terminal cavity and wherein the wire dress cover includes a secondary locking feature configured to further secure the electrical terminal within the terminal cavity.

In some aspects, the techniques described herein relate to an electrical connector assembly, wherein the first side of the wire dress cover includes the locking surface and the second side of the wire dress cover opposite the first side includes the contact surface.

In some aspects, the techniques described herein relate to an electrical connector assembly, wherein a leading edge of the tab is beveled and generates the force on the electrical terminal along the first axis as the tab is inserted within the slot.

In some aspects, the techniques described herein relate to an electrical connector assembly, wherein the force on the electrical terminal along the first axis reduces a gap between a free end of the connection portion and a mating connector housing.

In some aspects, the techniques described herein relate to an electrical connector assembly, wherein the wire dress cover includes a cover locking feature configured to cooperate with a corresponding cover locking feature in the connector housing to maintain the tab within the slot.

In some aspects, the techniques described herein relate to an electrical connector assembly, wherein the cover locking feature includes a pair of cantilevered resilient arms, each arm defining a locking latch near a free end of each arm and wherein the corresponding cover locking feature includes notches defined in the connector housing configured to receive the locking latch on each arm.

In some aspects, the techniques described herein relate to an electrical wiring assembly, including: an electrical terminal having a connection portion extending along a first axis and an attachment portion connected to an electrical cable extending along an a second axis askew to the first axis; a connector housing having a terminal cavity in which the electrical terminal is received, the connector housing defining a slot having a wall substantially parallel with the second axis; and a wire dress cover attached to the connector housing by a tab inserted within the slot, a locking surface of the tab being in contact with the wall of the slot, the locking surface and the wall being configured to urge a contact surface of the wire dress cover to exert a force on the electrical terminal along the first axis.

The electrical wiring assembly of the preceding paragraph can optionally include, additionally and/or alternatively any, one or more of the following features/steps, configurations, and/or additional components.

In some aspects, the techniques described herein relate to an electrical wiring assembly, wherein the first axis is arranged substantially perpendicular to the second axis.

In some aspects, the techniques described herein relate to an electrical wiring assembly, wherein a leading edge of the tab is beveled and generates the force on the electrical terminal along the first axis as the tab is inserted within the slot.

In some aspects, the techniques described herein relate to an electrical wiring assembly, wherein the wire dress cover includes a cover locking feature configured to cooperate with a corresponding cover locking feature in the connector housing to maintain the tab within the slot.

In some aspects, the techniques described herein relate to an electrical wiring assembly, wherein the electrical cable is a coaxial electrical cable.

In some aspects, the techniques described herein relate to an electrical wiring assembly, further including a plurality of the electrical terminal and a plurality of the electrical cable.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A wire dress cover configured to be attached to a connector housing containing a terminal, comprising:
a tab extending from the wire dress cover, the tab configured to be inserted within a slot defined in the connector housing, the tab having a locking surface configured to contact a wall in the slot, the locking surface and the wall being configured to cooperatively urge a contact surface of the wire dress cover to exert a force on the terminal within the connector housing.

2. The wire dress cover in accordance with claim 1, further comprising a locking feature configured to secure the terminal within the connector housing.

3. The wire dress cover in accordance with claim 1, wherein a first side of the wire dress cover comprises the locking surface and a second side of the wire dress cover opposite the first side comprises the contact surface.

4. The wire dress cover in accordance with claim 1, wherein a leading edge of the tab is beveled and is configured to generate the force on the terminal as the tab is inserted within the slot.

5. The wire dress cover in accordance with claim 1, wherein the wire dress cover comprises a cover locking feature configured to cooperate with a corresponding cover locking feature in the connector housing to maintain the tab within the slot.

6. The wire dress cover in accordance with claim 5, wherein the cover locking feature comprises a pair of cantilevered resilient arms, each arm defining a locking latch near a free end of each arm.

7. An electrical connector assembly, comprising:
a connector housing having a terminal cavity configured to receive an electrical terminal having a connection portion extending along a first axis and an attachment portion extending along a second axis askew to the first axis, the connector housing defining a slot having a wall substantially parallel with the second axis; and
a wire dress cover attached to the connector housing by a tab inserted within the slot, a locking surface of the tab being in contact with the wall of the slot, the locking surface and the wall being configured to cooperatively urge a contact surface of the wire dress cover to exert a force on the electrical terminal along the first axis.

8. The electrical connector assembly in accordance with claim 7, wherein the first axis is arranged substantially perpendicular to the second axis.

9. The electrical connector assembly in accordance with claim 7, wherein the connector housing comprises a primary locking feature configured to secure the electrical terminal within the terminal cavity and wherein the wire dress cover comprises a secondary locking feature configured to further secure the electrical terminal within the terminal cavity.

10. The electrical connector assembly in accordance with claim 7, wherein a first side of the wire dress cover comprises the locking surface and a second side of the wire dress cover opposite the first side comprises the contact surface.

11. The electrical connector assembly in accordance with claim 7, wherein a leading edge of the tab is beveled and generates the force on the electrical terminal along the first axis as the tab is inserted within the slot.

12. The electrical connector assembly in accordance with claim 7, wherein the force on the electrical terminal along the first axis reduces a gap between a free end of the connection portion and a mating connector housing.

13. The electrical connector assembly in accordance with claim 7, wherein the wire dress cover comprises a cover locking feature configured to cooperate with a corresponding cover locking feature in the connector housing to maintain the tab within the slot.

14. The electrical connector assembly in accordance with claim 13, wherein the cover locking feature comprises a pair of cantilevered resilient arms, each arm defining a locking latch near a free end of each arm and wherein the corresponding cover locking feature comprises notches defined in the connector housing configured to receive the locking latch on each arm.

15. An electrical wiring assembly, comprising:
an electrical terminal having a connection portion extending along a first axis and an attachment portion connected to an electrical cable extending along a second axis askew to the first axis;
a connector housing having a terminal cavity in which the electrical terminal is received, the connector housing defining a slot having a wall substantially parallel with the second axis; and
a wire dress cover attached to the connector housing by a tab inserted within the slot, a locking surface of the tab being in contact with the wall of the slot, the locking surface and the wall being configured to urge a contact surface of the wire dress cover to exert a force on the electrical terminal along the first axis.

16. The electrical wiring assembly in accordance with claim 15, wherein the first axis is arranged substantially perpendicular to the second axis.

17. The electrical wiring assembly in accordance with claim 15, wherein a leading edge of the tab is beveled and generates the force on the electrical terminal along the first axis as the tab is inserted within the slot.

18. The electrical wiring assembly in accordance with claim 15, wherein the wire dress cover comprises a cover locking feature configured to cooperate with a corresponding cover locking feature in the connector housing to maintain the tab within the slot.

19. The electrical wiring assembly in accordance with claim 15, wherein the electrical cable is a coaxial electrical cable.

20. The electrical wiring assembly in accordance with claim 15, further comprising a plurality of the electrical terminal and a plurality of the electrical cable.
